(19) United States
(12) Patent Application Publication
(10) Pub. No.: US 2017/0356536 A1
(43) Pub. Date: Dec. 14, 2017

(54) LIGHTWEIGHT AND NARROW DIFFERENTIAL ASSEMBLY WITH POWDER METAL INSERTS

(71) Applicant: Dana Automotive Systems Group, LLC, Maumee, OH (US)

(72) Inventors: Bruce N. Bordner, Angola, IN (US); Juan C. Parisca, Toledo, OH (US); Jon D. Strausbaugh, Monclova, OH (US); Edwin L. Underwood, Toledo, OH (US)

(21) Appl. No.: 15/618,882

(22) Filed: Jun. 9, 2017

Related U.S. Application Data
(60) Provisional application No. 62/348,043, filed on Jun. 9, 2016.

(51) Int. Cl. F16H 48/08; F16H 57/037; F16H 48/40; B21D 22/02; F16H 57/02; F16H 48/38

(52) U.S. Cl. CPC F16H 48/08; F16H 48/40; B21D 22/02; F16H 57/037; F16H 2048/385; F16H 2057/02017

(57) ABSTRACT

An axle assembly comprising a differential carrier including an upper portion coupled with a lower portion, the upper portion comprising a planar surface defining a first hollow protrusion and a second hollow protrusion. The first hollow protrusion and the second hollow protrusion each define an arcuate cavity. An input shaft is coupled with a pinion gear drivingly engaged with a ring gear at least partially disposed within the first hollow protrusion. A differential case having a first portion and a second portion is at least partially disposed in the second hollow protrusion. The ring gear is welded to an exterior surface of said differential case first portion. A plurality of axially extending slots are defined by an interior surface of the differential case first portion. An annular canister having radially extending lugs disposed on an outer surface thereof, is disposed within said differential case. The lugs are in driving engagement with the plurality of differential case slots. A plurality of apertures are radially disposed through the canister, and a plurality of pinion shafts are disposed through and drivingly engaged with the canister apertures. A pinion gear is disposed on each of the pinion shafts. A pair of side gears is in driving engagement with the pinion gears. A first output shaft is in driving engagement with one of the pair of side gears, and a second output shaft is in driving engagement with the other of the pair of side gears.

### RELATED APPLICATIONS

The present application claims the benefit to U.S. Provisional Application No. 62/348,043 filed on Jun. 9, 2016, which is incorporated herein by reference in its entirety.

### BACKGROUND OF THE INVENTION

The present disclosure relates to an axle assembly and means of torque conveyance. Axle assemblies in wheeled vehicle drivetrains are known to employ a differential apparatus to transmit torque from a power source to the vehicle wheels. The differential apparatus also permits an outer drive wheel to rotate at a greater velocity than an inner drive wheel when operating a vehicle through a turn.

Conventional axle assemblies are large and heavy. The present subject matter discloses an axle assembly and differential apparatus with greater torque capacity in a lighter weight and smaller packaging.

### SUMMARY

The present disclosure provides for an axle assembly comprising a differential carrier including an upper portion coupled with a lower portion, the upper portion comprising a planar surface defining a first hollow protrusion and a second hollow protrusion. The first hollow protrusion and the second hollow protrusion each define an arcuate cavity. An input shaft is coupled with a pinion gear drivingly engaged with a ring gear at least partially disposed within the first hollow protrusion. A differential case having a first portion and a second portion is at least partially disposed in the second hollow protrusion. The ring gear is welded to an exterior surface of said differential case first portion. A plurality of axially extending slots are defined by an interior surface of the differential case first portion. An annular canister having radially extending lugs disposed on an outer surface thereof, is disposed within said differential case. The lugs are in driving engagement with the plurality of differential case slots. A plurality of apertures are radially disposed through the canister, and a plurality of pinion shafts are disposed through and drivingly engaged with the canister apertures. A pinion gear is disposed on each of the pinion shafts. A pair of side gears is in driving engagement with the pinion gears. A first output shaft is in driving engagement with one of the pair of side gears, and a second output shaft is in driving engagement with the other of the pair of side gears.

### BRIEF DESCRIPTION OF THE SEVERAL VIEWS OF THE DRAWINGS

The accompanying drawings are incorporated herein as part of the specification. The drawings described herein illustrate embodiments of the presently disclosed subject matter, and are illustrative of selected principles and teachings of the present disclosure and do not illustrate all possible implementations thereof. The drawings are not intended to limit the scope of the present disclosure in any way.

FIG. 1 is a perspective view of an axle assembly according to an embodiment of the presently disclosed subject matter;

FIG. 2 is a perspective view of a portion of the axle assembly according to FIG. 1;

FIG. 3 is another perspective view of the portion of the axle assembly according to FIG. 2;

FIG. 4 is a perspective of a portion of the axle assembly according to FIG. 1;

FIG. 5 is a cross-sectional view of a portion of the axle assembly according to FIG. 1;

FIG. 6 is a perspective view of the differential apparatus of the axle assembly according to FIG. 1; and

FIG. 7 is a cross-sectional view of the differential apparatus according to FIG. 6.

### DETAILED DESCRIPTION OF EMBODIMENTS

It is to be understood that the invention may assume various alternative orientations and step sequences, except where expressly specified to the contrary. It is also to be understood that the specific devices, assemblies, systems and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

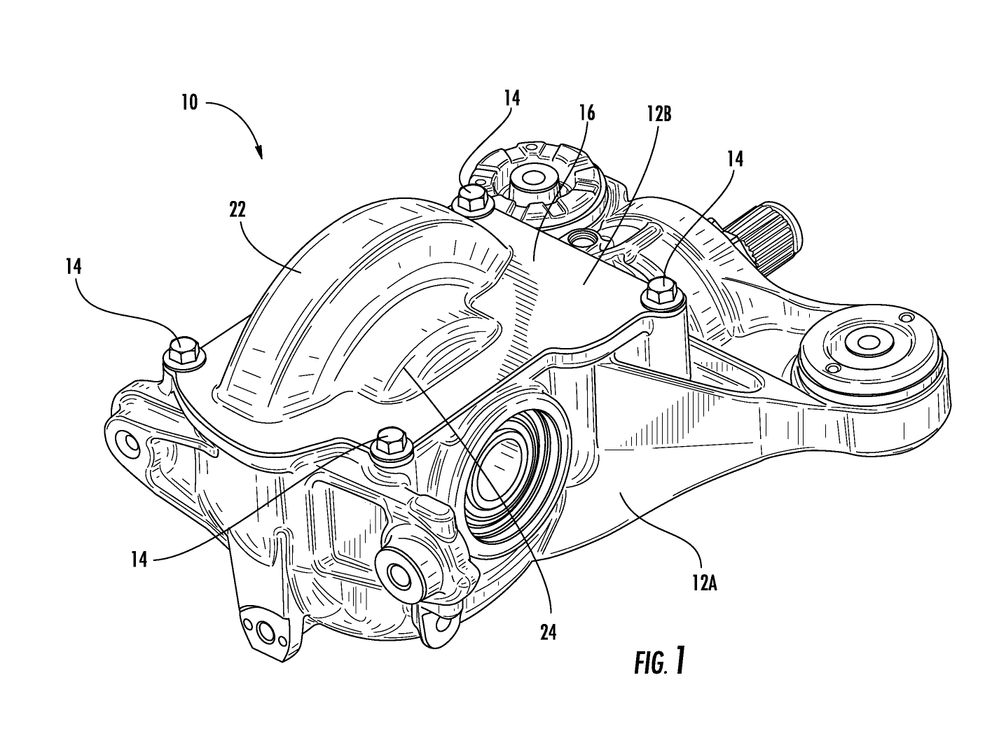

An axle assembly 10 may be provided for use in a drive train. As illustrated in FIG. 1, the axle assembly 10 comprises a lower carrier housing 12A and an upper carrier housing 12B. In an embodiment, the lower carrier housing 12A and the upper carrier housing 12B are coupled together via a plurality of fasteners 14. The upper carrier housing 12B comprises a substantially flat portion 16 through which fastener apertures 18 are disposed. The fasteners 14 are located at least partially through the apertures 18 and into corresponding bores (not depicted) in the lower carrier housing 12A.

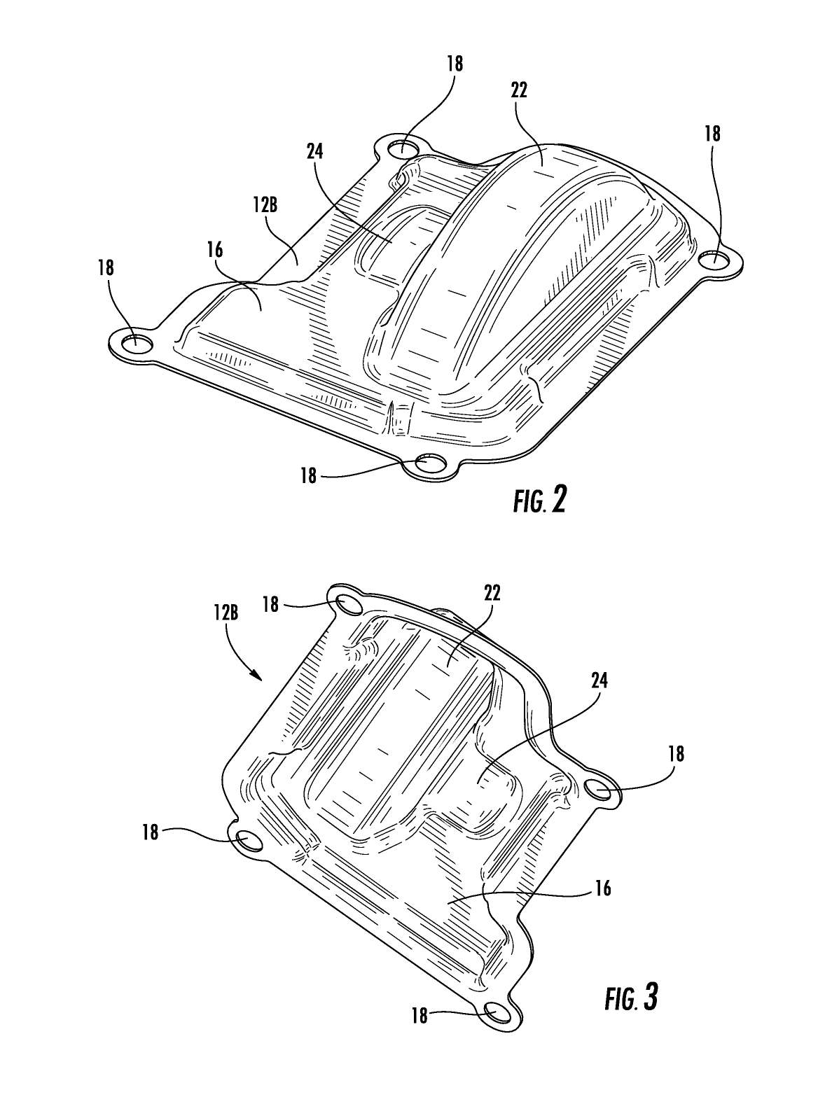

As illustrated in FIGS. 1-3, the upper carrier housing 12B also comprises a first hollow protrusion 22 and a second hollow protrusion 24, each extending transverse the flat portion 16. The first hollow protrusion 22 and the second hollow protrusion 24 may each comprise a substantially arcuate geometry. Further, the first hollow protrusion 22 and second hollow protrusion 24 may comprise a stepped, unitary hollow protrusion. The first hollow protrusion 22 accommodates a ring gear 104, of which a portion is located above the upper surface of the flat portion 16 such that a portion of the ring gear 104 is disposed in the first hollow protrusion 22. The second hollow protrusion 24 accommodates a differential case 105, of which a portion is also located above the upper surface of the flat portion 16 such that a portion of the differential case 105 is located in the second hollow protrusion 24. In an embodiment, the first and second hollow protrusions 22, 24 may comprise other shapes that allow portions of the ring gear 104 and differential case 105 to be disposed therein.

To reduce the size and weight of the axle assembly 10, as compared to conventional differential assemblies, the differential carrier housing 12A, 12B is narrow in the transverse axis (i.e., crosswise) direction parallel with the longitudinal axis of the axle assembly 10.

The upper carrier housing 12B may comprise a metallic material such as, but not limited to, steel, premium carbon steel, aluminum, and aluminum alloys. In addition, the upper carrier housing 12B may be formed by a process of single-stage or multi-stage stamping or pressing. During maintenance of the axle assembly 10, or installation/removal of a differential case assembly 100, the upper carrier housing 12A is separated from the lower carrier housing 12B by at least partially removing the fasteners 14.

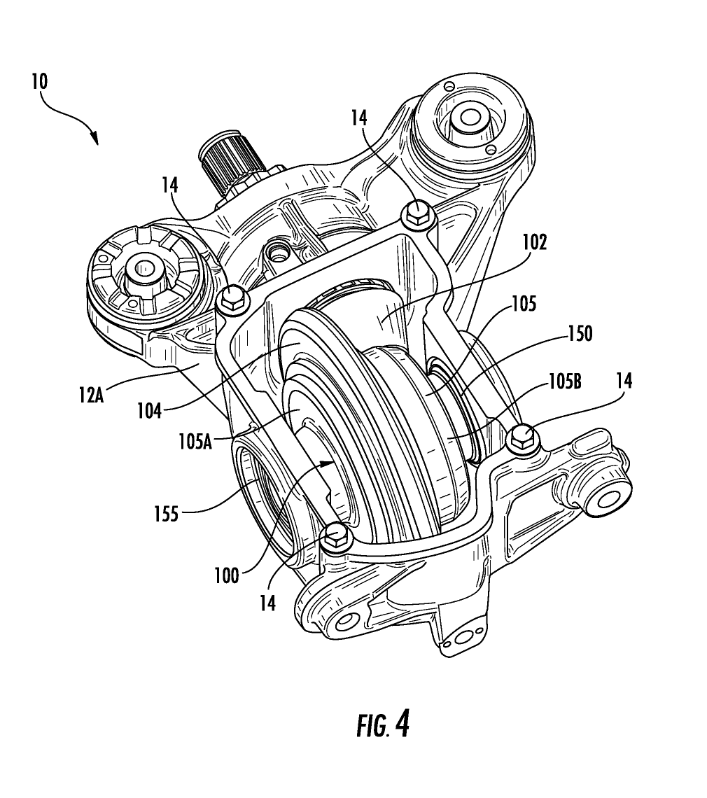

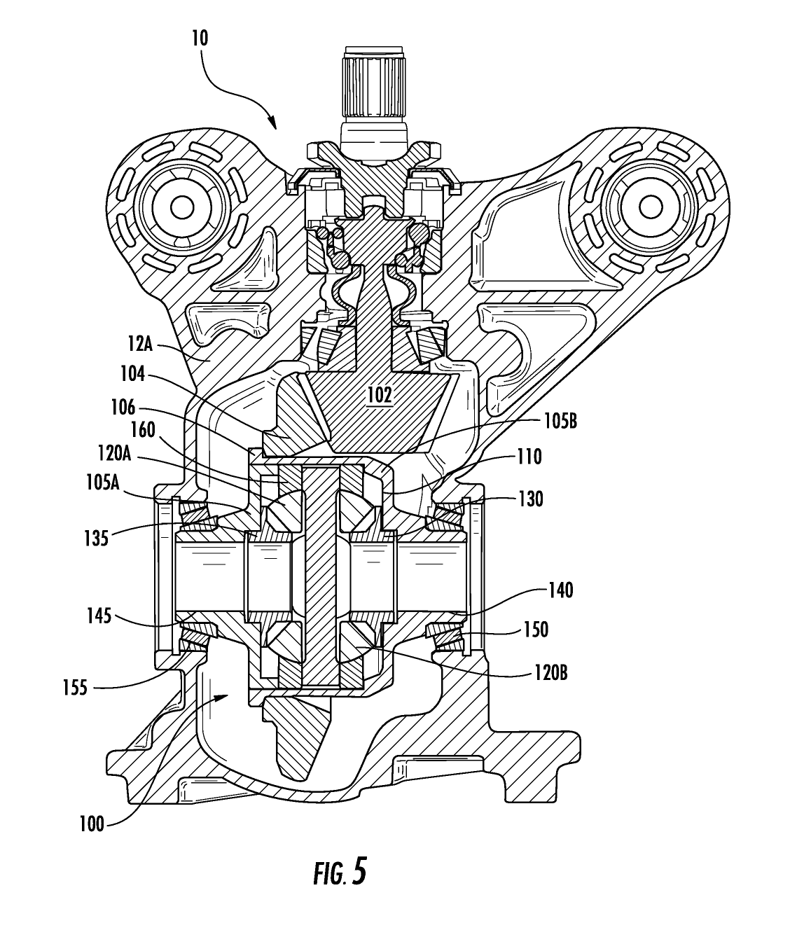

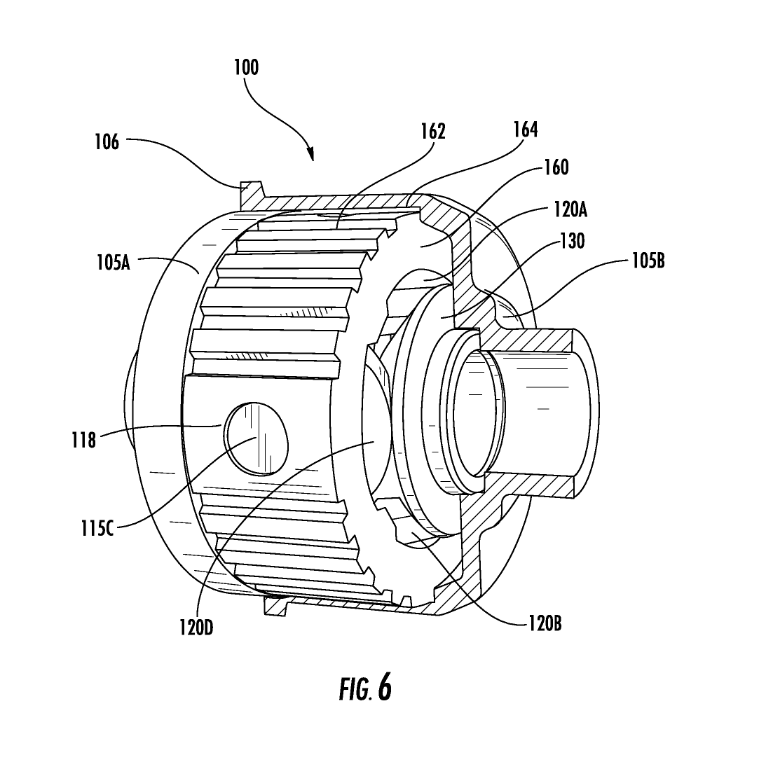

As illustrated in FIGS. 4-5, a pinion gear 102 is located in the carrier housing 12A, 12B to convey torque from a drive power source (not depicted) to the ring gear 104. The ring gear 104 is coupled with the differential case 105 of the differential case assembly 100, and the case 105 is rotated with the ring gear 104 when driven by the pinion gear 102. In an embodiment, the ring gear 104 may comprise a webbed gear. In an embodiment, the ring gear 104 is coupled with the case 105 via laser welding. The interface between the ring gear 104 and the case 105 may comprise an axial or radial gap which allows for an axial or radial welding process to be utilized.

The differential case 105 is mounted for rotation within the differential carrier housing 12A, 12B via bearings 150, 155. The bearings 150, 155 are disposed about a trunnion, or cylindrical protrusion, on opposing portions of the differential case 105 to support the differential case 105 inside the differential carrier housing 12A, 12B. In an embodiment, the differential case 105 may be produced via the process of flow forming a metallic material such as, but not limited to, steel, premium carbon steel, aluminum, and aluminum alloys.

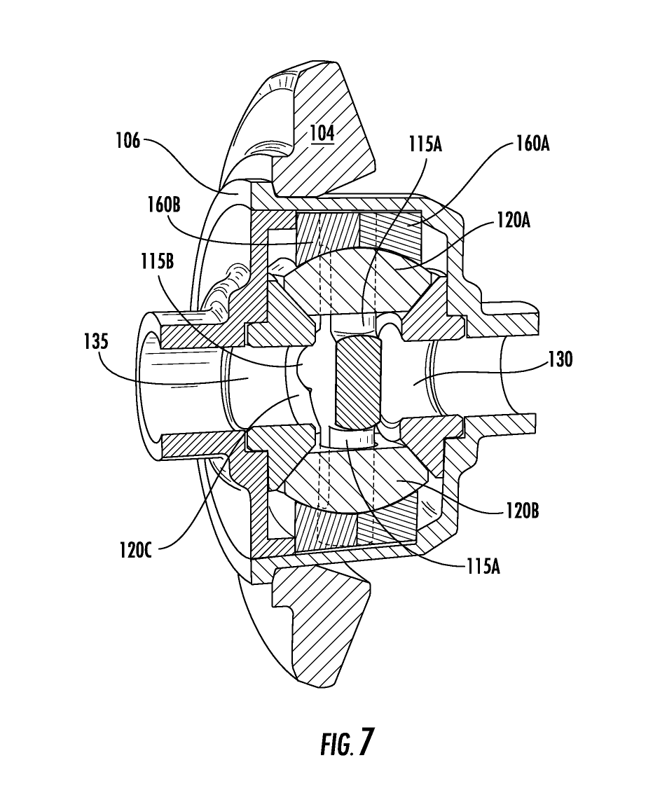

As illustrated in FIGS. 4-7, in an embodiment, the differential case 105 comprises a first portion 105A and a second portion 105B. The first and second portions 105A and 105B may be welded together utilizing a laser welding process. The differential case 105 further comprises a hollow interior defined by an interior surface 110. The differential case assembly 100 may be a four-pin differential having a canister 160. The canister 160 may comprise an annular member having a plurality of axially extending lugs 162 disposed on an exterior surface thereof. The lugs 162 may mate with grooves 164 provided on the interior surface of the differential case 105 to align the canister 160 when in the differential case assembly 100. In an embodiment, the canister 160 may further comprise four equally spaced apertures 118 through exterior surface and interior surface thereof for receiving pinion gear shafts (i.e., spider shafts). In another embodiment, the apertures 118 are not equally spaced.

Further, in an embodiment as illustrated in FIG. 7, the canister 160 may comprise a first portion 160A and a second portion 160B. The first and second canister portions 160A, 160B may comprise annular members having external lugs 162 which are aligned. The interior of the canister 160 comprises an arcuate geometry defining a portion of a substantially spherical shape to accommodate a plurality of pinion gears 120A, 120B, 120C, 120D disposed therein.

In addition, the canister 160 may be formed at least in part by a process of powder metallurgy or sintering to allow the transfer of high torque and high revolutions per minute. It will be apparent to those skilled in the pertinent arts that the canister 160 may also be produced utilizing conventional manufacturing processes.

In an embodiment, a first spider shaft 115A extends through the canister 160 and is coupled at its ends in two opposing apertures 118 of the canister 160. A first and second pinion gear 120A, 120B, are mounted on each end of the first spider shaft 115A inside the canister 160. A second spider shaft 1156 extends into the canister 160 transverse the first spider shaft 115A and is coupled at a first end in another aperture 118 of the canister 160. A second end of the second spider shaft 1156 may be disposed in an aperture (not depicted) in the first spider shaft 115A. A third pinion gear 120C is mounted on the spider shaft 1156 inside the canister 160. A third spider shaft 115C extends into the canister 160 opposite the second spider shaft 1156 and is coupled at a first end in an aperture 118 of the canister 160. A second end of the third spider shaft 115C may be disposed in an aperture (not depicted) in the first spider shaft 115A. A fourth pinion gear 120C is mounted on the third spider shaft 115C inside the canister 160. The assembly of the first spider shaft 115A, the second spider shaft 1156, the third spider shaft 115C, and the pinion gears 120A, 120B, 120C, 120D comprises a pinion gear assembly 116.

In another embodiment, not depicted, a first spider shaft 115A extends into the canister 160 transverse a longitudinal axis of the canister 160 and is coupled at a first end in an aperture of the canister 160. A first pinion gear 120A is mounted on a second end of the spider shaft 115A inside the canister 160. A second spider shaft 1156 extends into the canister 160 opposite the first spider shaft 115A and is coupled at a first end in another aperture of the canister 160. A second pinion gear 120B is mounted on a second end of the spider shaft 1156 inside the canister 160. A third spider shaft 115C extends into the canister 160 transverse the first and second spider shafts 115A, 1156 and is coupled at a first end in another aperture of the canister 160. A third pinion gear 120C is mounted on a second end of the spider shaft 115C inside the canister 160. A fourth spider shaft 115D extends into the canister 160 opposite the third spider shaft 115C, and transverse the first and second spider shaft 115A, 115B, and is coupled at a first end in another aperture of the canister 160. A fourth pinion gear 120D is mounted on a second end of the spider shaft 115D inside the canister 160.

In another embodiment, not depicted, the pinion gears 120A, 120B, 120C, 120D are supported in the canister 160 by a unitary cross pin 115. The cross pin 115 may comprise shafts 115A, 115B, 115C, 115D extending radially such that an end of each shaft supports one of the pinion gears 120A, 120B, 120C, 120D and is disposed through a canister 160 aperture.

The pinion gears 120A, 120B, 120C, 120D are meshed with a first side gear 130 and a second side gear 135 within the differential case 105. The side gears 130, 135 comprise internal splines to engage axle half shafts (not depicted) or stub shafts (not depicted). The differential case 105 comprises bores 140 and 145 through the differential case 105 trunnions to accommodate the half shafts or stub shafts coupled with the side gears 130, 135. The axle half shafts or stub shafts are inserted into the bores 140, 145 and into the side gears 130, 135 where they engage the side gear 130,135 internal spline portions. In an embodiment, the axle half shafts or stub shafts are secured in their position in the differential case assembly 100 by c-clips (not depicted) inserted into grooves in the axle half shafts.

The differentical case assembly 100 may be assembled by sliding the ring gear 104 onto the exterior surface of the second case portion 1056 such that a portion of the ring gear 104 abuts second case portion 1056 flange 106. The ring gear 104 is then laser welded to the second case portion 1056 where the ring gear 104 abuts the flange 106. The second side gear 135 may then be located inside the second case portion 1056 such that its gear teeth substantially face the center of the differential case 105. The second canister portion 160B may then be slid into engagement with the corresponding interior grooves in the second case portion 105B, such that the second canister portion 160B is in the preferred alignment with its arcuate interior facing the center of the differential case 105. The pinion gear assembly 116 having the pinion gears 120A, 120B, 120C, 120D located on the shafts 115A, 115B, 115C, may then be located in the second canister portion 1606. The shafts 115A, 1156, 115C are disposed in the half apertures defined by the second canister portion 160B. In the embodiment comprising the first and second canister portions 160A, 160B, the first canister portion 160A may then be installed in the second case portion 105B. The first and second canister portions 160A, 160B define half apertures comprising the apertures 118 of the canister 160. The half apertures align with the shafts 115A, 1156, 115C and create the plurality of apertures 118 through the canister 160. The first side gear 130 may then be placed into engagement with the pinion gear assembly 116 inside the second case portion 1056. Next, the first case portion 105A may be coupled with the second case portion 1056 such that an outer surface 108 of the first case portion 105A abuts an interior surface of the second case portion 105B. The first case portion 105A comprises an annular portion creating a flange which abuts the first canister portion 160A. The first case portion 105A may be laser welded to the second case portion 105B.

While various embodiments have been described above, it should be understood that they have been presented by way of example, and not limitation. It will be apparent to persons skilled in the relevant art that the disclosed subject matter may be embodied in other specific forms without departing from the spirit or essential characteristics thereof. The embodiments described above are therefore to be considered in all respects as illustrative, not restrictive.

What is claimed is:

1. An axle assembly, comprising:
a differential carrier including an upper portion coupled with a lower portion, said upper portion comprising a planar surface defining a first hollow protrusion and a second hollow protrusion extending transverse said planar surface;
said first hollow protrusion and said second hollow protrusion each defining an arcuate cavity;
an input shaft coupled with a pinion gear;
a ring gear at least partially disposed within said first hollow protrusion and in driving engagement with said pinion gear;
a differential case having a first portion and a second portion at least partially disposed in said second hollow protrusion, wherein said ring gear is welded to an exterior surface of said first portion;
a plurality of axially extending slots defined by an interior surface of said differential case first portion;
an annular canister having radially extending lugs disposed on an outer surface thereof, wherein said lugs are in driving engagement with said plurality of differential case slots;
a plurality of apertures radially disposed through said canister;
a plurality of pinion shafts disposed through and drivingly engaged with said canister apertures;
a pinion gear disposed on each said pinion shaft;
a pair of side gears in driving engagement with said pinion gears; and
a first output shaft in driving engagement with one of said pair of side gears; and
a second output shaft in driving engagement with one of said pair of side gears.

2. The axle assembly according to claim 1, wherein said first hollow protrusion extends radially further than said second hollow protrusion.

3. The axle assembly according to claim 1, wherein said annular canister comprises a first portion and a second portion.

4. The axle assembly according to claim 3, wherein said canister first portion comprises an inboard surface; and
said canister second portion comprises an inboard surface abutting said canister first portion inboard surface.

5. The axle assembly according to claim 1, wherein said plurality of canister apertures are equally spaced about said canister.

6. The axle assembly according to claim 1, comprising four pinion shafts and four pinion gears disposed thereon.

7. The axle assembly according to claim 1, wherein said annular canister comprises fused metal powder.

8. The axle assembly according to claim 1, wherein said first hollow protrusion and said second hollow protrusion comprise a stepped unitary hollow protrusion.

9. A method for producing a differential carrier upper portion, which comprises:
providing a piece of sheet metal;
stamping said piece of sheet metal to produce a first hollow protrusion and a second hollow protrusion, wherein said first hollow protrusion and said second hollow protrusion each define an arcuate cavity; and
removing material from said piece of sheet metal to produce a plurality of fastener apertures.
